(19) United States
(12) Patent Application Publication
(10) Pub. No.: US 2022/0067868 A1
(43) Pub. Date: Mar. 3, 2022

(54) DIFFERENTIATED ACCESS CONTROL IN CAR SHARING SERVICE

(71) Applicant: GM GLOBAL TECHNOLOGY OPERATIONS LLC, Detroit, MI (US)

(72) Inventors: Jinzhu Chen, Troy, MI (US); Fan Bai, Ann Arbor, MI (US); John Sergakis, Bloomfield Hills, MI (US); Thomas E. Utter, Royal Oak, MI (US)

(73) Assignee: GM GLOBAL TECHNOLOGY OPERATIONS LLC, Detroit, MI (US)

(21) Appl. No.: 17/008,164

(22) Filed: Aug. 31, 2020

(51) Int. Cl. G06Q 50/30; G07C 9/00

(52) U.S. Cl. CPC G06Q 50/30; G07C 9/00571; G07C 9/00896

(57) ABSTRACT

Systems and method are provided for customizing a user profile for a vehicle. In one embodiment, a method includes: customizing, at a first device, a user profile defining vehicle access for one or more users of the vehicle; providing, to a second device, an access key and the user profile through a first communication channel; providing, to the vehicle, the user profile through a second communication channel; verifying the user profile of the second device with the user profile of the vehicle; and in response to the verifying, storing, in the vehicle, the access key.

### INTRODUCTION

The present disclosure generally relates to vehicles, and more particularly relates to systems and methods for differentiated levels of vehicle access control to various users.

Personal devices, such as phones, tablets, smart devices, etc., may be used to access a vehicle. For example, an application may be downloaded on the personal device and configured to allow a user to lock and unlock the doors of the vehicle, and/or to turn on and turn off the vehicle. The application is typically configured to allow for fixed functions under a standardized user profile. Standard user profiles do not define the detailed features/functions behind each profile. Each manufacturer defines a fixed set of features/functions supported by each profile. Standardized user profiles have a limited number of different profiles, which may not cover the current and future variety of customer use cases. Currently there is no mechanism for users to customize what features are included in the profile for their specific sharing use cases, especially for rental or peer to peer use cases.

Accordingly, it is desirable to provide systems and methods that allow for flexible customization of user profiles relating to vehicle access. Furthermore, other desirable features and characteristics of the present disclosure will become apparent from the subsequent detailed description and the appended claims, taken in conjunction with the accompanying drawings and the foregoing technical field and background.

### SUMMARY

Systems and method are provided for customizing a user profile for a vehicle. In one embodiment, a method includes: customizing, at a first device, a user profile defining vehicle access for one or more users of the vehicle; providing, to a second device, an access key and the user profile through a first communication channel; providing, to the vehicle, the user profile through a second communication channel; verifying the user profile of the second device with the user profile of the vehicle; and in response to the verifying, storing, in the vehicle, the access key.

In various embodiments, the first device is a user device of an owner of the vehicle, and wherein the second device is a user device of an other user of the vehicle.

In various embodiments, the first device is a fleet management server, and wherein the second device is a user device of a user of the vehicle.

In various embodiments, the first device is a user device of a user of the vehicle, and wherein the second device is a fleet management server.

In various embodiments, the first communication channel includes a uniform resource locator. In various embodiments, the second communication channel includes a telematics system.

In various embodiments, the customizing the user profile comprises assigning one or more contexts to one or more functions of the vehicle. In various embodiments, the customizing the user profile comprises assigning one or more functions to one or more user roles.

In various embodiments, the method includes dynamically executing the one or more functions for a user associated with a first user role based on the user profile. In various embodiments, the context includes at least one of a time of day, a current weather, a time of year, and a day of the week.

In another embodiment, a system includes: a first module configured to, by a processor of a first device, customize a user profile defining vehicle access for one or more users of the vehicle; a second module configured to, by a processor, provide an access key and the user profile through a first communication channel to a second device; a third module, configure to, by a processor, provide the user profile through a second communication channel to the vehicle; a fourth module configured to, by a processor, verify the user profile of the first communication channel with the user profile of the second communication channel, and in response to the verifying, store the access key in the vehicle.

In various embodiments, the first device is a user device of an owner of the vehicle, and wherein the second device is a user device of an other user of the vehicle.

In various embodiments the first device is a fleet management server, and wherein the second device is a user device of a user of the vehicle.

In various embodiments, the first device is a user device of a user of the vehicle, and wherein the second device is a fleet management server.

In various embodiments, the first communication channel includes a uniform resource locator. In various embodiments, the second communication channel includes a telematics system.

In various embodiments, the first module customizes the user profile by assigning one or more contexts to one or more functions of the vehicle. In various embodiments, the first module customizes the user profile by assigning one or more functions to one or more user roles.

In various embodiments, they system further includes a fourth module configured to, by a processor, dynamically execute the one or more functions for a user associated with a first user role based on the user profile. In various embodiments, the context includes at least one of a time of day, a current weather, a time of year, and a day of the week.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a transportation system having one or more vehicles capable of user customization, in accordance with various embodiments;

FIGS. 2, 3, and 4 are flow diagrams illustrating customization systems, in accordance with various embodiments; and

FIG. 5 is a flow diagram illustrating a context module and process for executing the functions of the user profiles based on the customized context, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

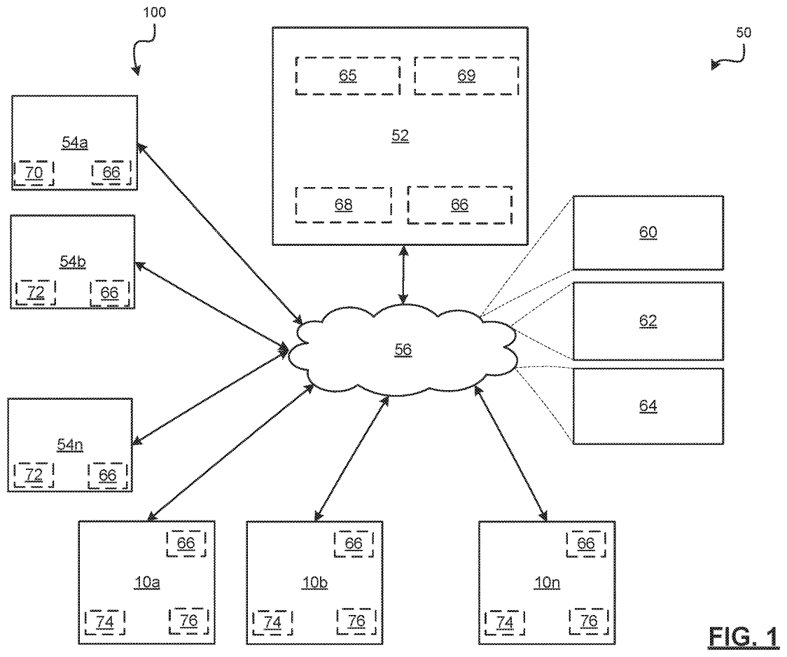

With reference to FIG. 1, a customization system shown generally at 100 is associated with a vehicle 10 in accordance with various embodiments. In general, the customization system 100 allows for differentiated levels of access control to various users of the vehicle 10.

In various embodiments, the vehicle 10 described with regard to FIG. 1 may be a personal vehicle or maybe suitable for use in the context of a taxi or shuttle system in a certain geographical area (e.g., a city, a school or business campus, a shopping center, an amusement park, an event center, or the like) or may simply be managed by a remote system. For example, the vehicle 10 may be associated with an operating environment shown generally at 50 that includes a remote transportation system 52. In various embodiments, the operating environment 50 includes one or more user devices 54 that communicate with the vehicle 10 and/or the remote transportation system 52 via a communication network 56. In various embodiments, the vehicle 10 includes a telematics system for communicating via the communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62 but can include wireless telephony equipment so that it can communicate directly with a wireless network, such as the wireless carrier system 60.

Embodiments of the operating environment 50 can support any number of user devices 54, including multiple user devices 54 owned, operated, or otherwise used by one or more persons. In the exemplary embodiments described herein, the user devices 54 include at least a user device 54a associated with the owner of the vehicle 10 and a user device 54b associated with another user of the vehicle 10.

Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. For exemplary purposes the remote transportation system 52 will be discussed herein as a cloud-based system. The remote transportation system 52 includes a fleet manager module 65 that can communicate with the user devices 54 and the vehicles 10 to customize user profiles 66, schedule rides, dispatch autonomous vehicles 10, and the like. In various embodiments, the remote transportation system 52 stores in a database 69 account information such as the customized user profiles 66 described herein as well as subscriber authentication information, vehicle identifiers, profile records, behavioral patterns, and/or other pertinent subscriber information.

In various embodiments, the customization system 100 implements a flexible profile customization protocol (FPCP) that negotiates and customizes functions of the customized user profiles 66 using modules associated with the different entities (e.g., the owner, the vehicle user, a fleet manager of the transportation system). For example, the customization system 100 implements the FPCP through a fleet manager customization module 68 implemented on the remote transportation system 52, an owner customization module 70 implemented on the owner user device 54a, a user customization module 72 implemented on the vehicle user device 54b, and a vehicle customization module 74 implemented on the vehicle 10.

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

In various embodiments, the modules 68-74 work collectively to customize the user profiles 66 and synchronize shared profile information across the vehicle 10, the remote transportation system 52, and the user devices 54 through confidential channels using multi-channel dynamic profile synchronization (MIDPS). In various embodiments, the modules 68-74 work collectively to provide a context-driven access profile (CDAP) design capability to configure profiles with context constraints under which certain functions can be limited. In various embodiments, the vehicles 10 further include a context module 76 that use the context constraints to dynamically execute the user profile during runtime and based on the current context of the vehicle 10.

As can be appreciated, the subject matter disclosed herein provides certain enhanced features and functionality to what may be considered as a standard or baseline vehicle 10 and/or a vehicle based remote transportation system 52. To this end, a vehicle and a vehicle based remote transportation system can be modified, enhanced, or otherwise supplemented to provide the additional features described in more detail below.

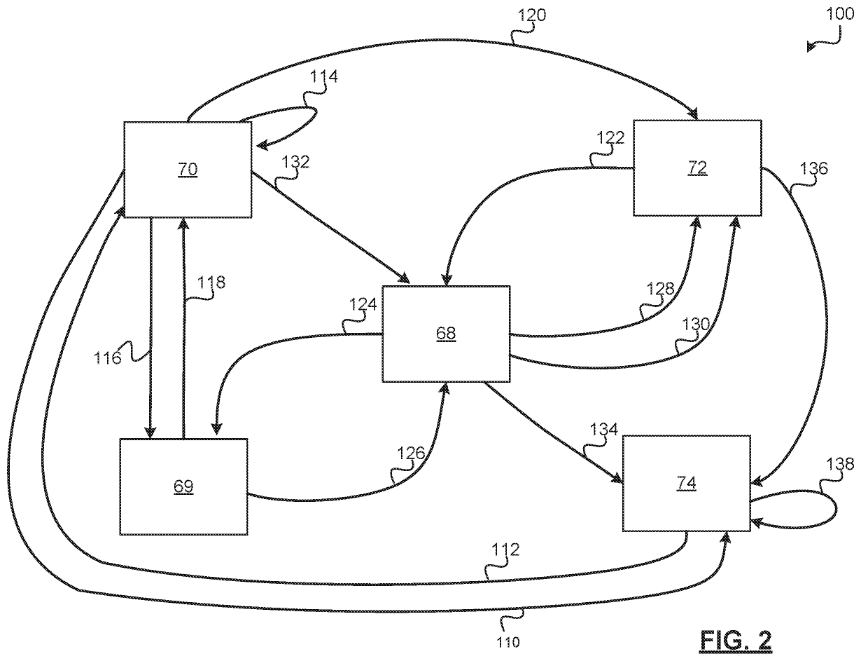

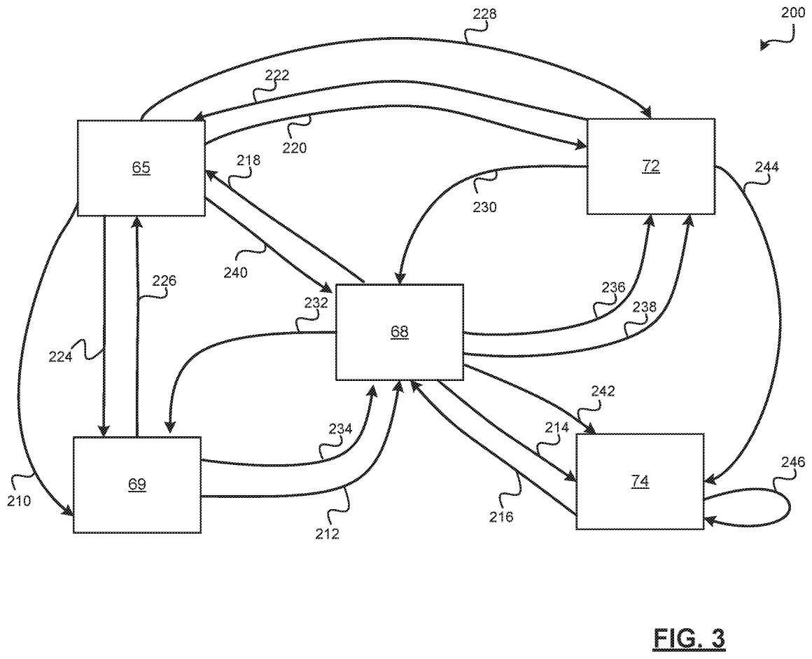

With reference now to FIGS. 2-4 and with continued reference to FIG. 1, flow diagrams illustrate various use cases and process flows 100. 200. 300 performed by the modules 66-74 of the system 100 according to the various embodiments. In accordance with a first process flow 100 of the customization system 100, as shown in FIG. 3, an owner of the vehicle 10 may use the user owner device 54a to customize the user profile 66 and synchronize the user profile 66 with the other user device 54b, the remote transportation system 52, and the vehicle 10.

For example, at 110 the owner initiates via the owner customization module 70 the pairing of the owner user device 54a with the vehicle 10 in which the owner establishes an access key to be used with the vehicle 10. In response, at 112, the vehicle 10 stores the owner's access key and synchronizes via the vehicle customization module 74 the available functions of the vehicle 10 with the list of available functions maintained by the owner customization module 70. The owner customization module 70 creates and stores the customized user profile 66 at 114 based on the functions and user configuration parameters entered by the user into the owner user device 54a.

For example, an exemplary user profile 66 can include a list of one or more user roles, a list of associated contexts, and a list of associated actions. Example user roles can include, but are not limited to, owner, co-owner, kids, friends, renter, delivery person, and valet. Example contexts can include, but are not limited to, weather, time of day, time of week, time of year, road conditions, and vehicle status. Example functions can include, but are not limited to, access functions, speed functions, and entertainment functions. An example user profile can be configured from user input as follows:

| Role | Context | Function |
|---|---|---|
| Owner | Any Context | Allow full access to all functions |
| Co-owner (e.g. | Any Context | Allow full access to all functions |
| wife, husband) | | |
| Friends | Daytime | Disable Radio/App Favorite; allow |
| | | autonomous driving |
| Friends | Nighttime | Disable Radio/App Favorite; disable |
| | | autonomous driving |
| Maven Sharing | Any Context | Disable Function XYZ; |
| Valet | Any Context | Only allow valet mode |
| | | Speed restriction = low range |

In various embodiments, once a customized user profile 66 is created each role of the user profile 66 is encoded according to an encoding method (e.g., JSON, byte encoding, etc.) and stored.

Thereafter, at a request can be generated by the owner customization module 70 to share the customized user profile 66 or a portion thereof (e.g., the portion relating to the user's role) with another user at 116. The request is sent to the remote transportation system 52 and received via the remote customization database 69 at 116. The remote customization database 69 shares an access uniform resource locator (URL). In response, the owner customization module 70 shares to the user customization module 72 the URL at 120. The user customization module 72 requests to redeem a user access key using the URL at 122. In response, the remote customization module 74 retrieves the user access key from a dynamic key service of the remote customization database 69 at 124 and 126 and sends the user access key and the user profile to the user customization module 72 at 128 through a first channel. A backup up file of the user profile 66 is also sent at 130 through a separate secure channel. In various embodiments, the user access key includes the owner access key and a unique user access key.

The remote customization module 68 performs a synchronization of the user profile 66 between the owner customization module 70 and the vehicle customization module 74 at 132 and 134 through a second channel. For example, in various embodiments the telematics system of the vehicle 10 can communicate with the remote customization module 68 to synchronize the profile 66. In various other embodiments, a short-range communication protocol such as Bluetooth can be used to can communicate with the owner customization module 70 to synchronize the user profile 66 directly when the owner approaches the vehicle 10. As can be appreciated, the synchronization of the user profile 66 between the owner customization module 70 and the vehicle customization module 74 can occur at various times and as such is not limited to the presented example.

The user customization module 72 then presents the user access key and the user profile to the vehicle customization module 74 at 136 through a third channel. The vehicle customization module 74 verifies the user access key and the user profile 66 at 138. For example, when the other user device 54b approaches the vehicle 10 for the first time, the other user device 54b sends the user access key and the user profile 66 to the vehicle 10 through a short-range communication such as Bluetooth. The vehicle 10 verifies this user access key with the owner key received at owner pairing. Then, the vehicle 10 compares the user profile 66 received by the third communication channel with the user profile 66 received by the second communication channel. Then, the new key from the user access key is stored by the vehicle 10 when verification is a success. In case the user profile 66 has not been received by the second communication channel, the vehicle customization module 74 will retrieve the backup user profile from the user customization module 72 through an independent fourth secure channel, for example, a short range communication channel such as Bluetooth.

In accordance with another process flow 200 of the customization system 100, as shown in FIG. 3, a fleet user associated with the remote transportation system 52 may use the user customization module 65 to customize the user profile 66 and synchronize the user profile 66 with the remote transportation system 52, and the vehicle 10.

For example, the vehicle owner initiates via the fleet manager module 65 the owner pairing with the vehicle 10 through the remote customization database 69 and the remote customization module 68 at 210, 212, and 214 in which the owner establishes an access key to be used with the vehicle 10. In response, at 216 and 218, the vehicle customization module 74 synchronizes the available functions of the vehicle 10 with the list of available functions maintained by the fleet manager module 65 through the remote customization module 68. The fleet manager module 65 shares the list of functions with the user customization module 72 at 220.

The user customization module 72 selects or creates the user profile 66 at 222, for example, as discussed above. In response, the fleet manager module 65 requests sharing of the user profile 66. For example, the request is sent to the remote transportation system 52 and received via the remote customization database 69 at 224. The remote customization database 69 shares an access URL to redeem a user access key with the fleet manager module 65 at 226. In response, the fleet manager module 65 shares to the user customization module 72 the URL at 228. The user customization module 72 requests to redeem the access the user key using the URL at 230. In response, the remote customization module 68 retrieves the user access key from a dynamic key service of the remote customization database 69 at 232 and 234 and sends the access key and the user profile 66 to the user customization module 72 at 236 through this first communication channel. A backup up file of the user profile 66 is also sent at 238 through a separate secure channel. In various embodiments, the user access key includes the owner access key and a unique user access key.

The remote customization module 68 performs a synchronization of the user profile 66 between the fleet manager module 65 and the vehicle customization module 74 through a second channel at 240 and 242. For example, in various embodiments the telematics system of the vehicle 10 can communicate with the remote customization module 68 to synchronize the profile 66. In various other embodiments, a short-range communication protocol such as Bluetooth can be used to can communicate with the owner customization module 70 to synchronize the user profile 66 directly when the user approaches the vehicle for the first time. As can be appreciated, the synchronization of the user profile 66 between the fleet manager module 65 and the vehicle customization module 74 can occur at various times and as such is not limited to the presented example.

The user customization module 72 then presents the user access key and the user profile to the vehicle customization module 74 at 244. The vehicle customization module 74 verifies the user access key and the user profile 66 at 246, for example, as discussed above. In case the user profile 66 has not been received through the second communication channel, the vehicle customization module 74 will retrieve the backup user profile 66 from the user customization module 72 through an independent fourth secure channel, for example, a short-range communication channel such as Bluetooth.

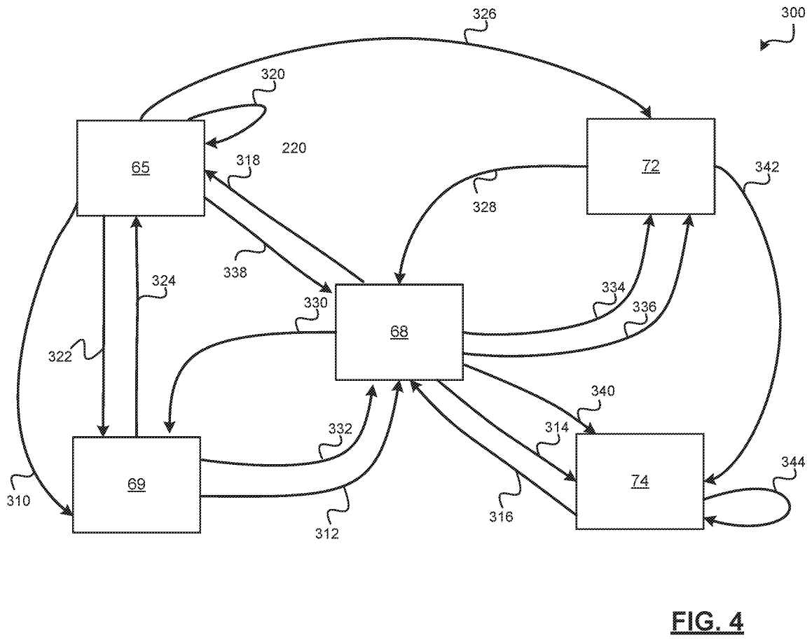

In accordance with another process flow 300 of the customization system 100, as shown in FIG. 4, a fleet manager associated with the remote transportation system 52 may use the fleet manager module 65 to customize the user profile 66 and synchronize the user profile 66 with the other user device 54b, and the vehicle 10.

For example, the fleet manager initiates via the fleet manager module 65 the owner pairing with the vehicle 10 through the remote customization database 69 and the remote customization module 68 at 310, 312, and 314 in which an owner key is established. In response, at 316 and 318, the vehicle customization module 74 synchronizes the available functions of the vehicle 10 with the list of available functions maintained by the fleet manager module 65 through the remote customization module 68. The fleet manager then selects or creates the user profile 66 at 322, for example, as discussed above. In response, the fleet manager module 65 requests sharing of the user profile 66.

For example, the request is sent to the remote transportation system 52 and received via the remote customization database 69 at 322. The remote customization database 69 shares an access URL to redeem a user access key with the fleet manager module 65 at 324. In response, the fleet manager module 65 shares to the user customization module 72 the URL at 326. The user customization module 72 requests to redeem the user access key using the URL at 328. In response, the remote customization module 68 retrieves the user access key from a dynamic key service of the remote customization database 69 at 330 and 332 and sends the user access key and the user profile 66 to the user customization module 72 at 334 through this first channel. A backup up file of the user profile 66 is also sent at 336 through a separate secure channel.

The remote customization module 68 performs a synchronization of the user profile 66 between the fleet manager module 65 and the vehicle customization module 74 at 338 and 340 through the second channel, for example, as discussed above.

The user customization module 72 then presents the user access key and the user profile to the vehicle customization module 74 at 342 through the third channel. The vehicle customization module 74 verifies the user access key and the user profile 66 at 344, for example, as discussed above. In case the user profile 66 has not been received by the second communication channel, the vehicle customization module 74 will retrieve the backup user profile from user customization module 72 through an independent fourth secure channel, for example, a short-range communication channel such as Bluetooth.

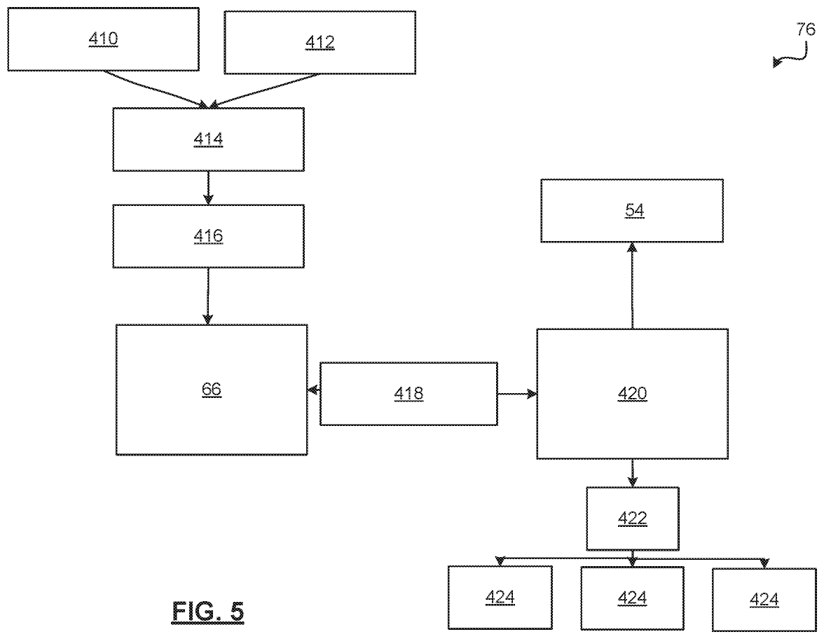

With reference now to FIG. 5 and with continued reference to FIG. 1, a flow diagram illustrates the context module 76 implemented by the vehicles 10 in accordance with various embodiments. The context module 76 manages the execution of the configured functions of the user profiles 66 and provides context feedback to the various users.

For example, vehicle data 410 and cloud data 412 are provided to a context engine 414. The context engine processes the data to determine the current context 416. The user profile 66 is evaluated to determine the functions 418 associated with the current context 416. A profile executor 420 receives the functions 418 and communicates function control signals through a gateway 422 to various function control electronic control units 424. The function control ECUs 424 then perform the function control. Optionally, context feedback is presented to the user (owner, other user, or fleet manager) via the user device 54.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of customizing a user profile for a vehicle, comprising:
customizing, at a first device, a user profile defining vehicle access for one or more users of the vehicle;
providing, to a second device, an access key and the user profile through a first communication channel;
providing, to the vehicle, the user profile through a second communication channel;
verifying the user profile of the second device with the user profile of the vehicle based on the access key; and
in response to the verifying, storing, in the vehicle, the access key.

2. The method of claim 1, wherein the first device is a user device of an owner of the vehicle, and wherein the second device is a user device of an other user of the vehicle.

3. The method of claim 1, wherein the first device is a fleet management server, and wherein the second device is a user device of a user of the vehicle.

4. The method of claim 1, wherein the first device is a user device of a user of the vehicle, and wherein the second device is a fleet management server.

5. The method of claim 1, wherein the first communication channel includes a uniform resource locator.

6. The method of claim 5, wherein the second communication channel includes a telematics system.

7. The method of claim 1, wherein the customizing the user profile comprises assigning one or more contexts to one or more functions of the vehicle.

8. The method of claim 7, wherein the customizing the user profile comprises assigning one or more functions to one or more user roles.

9. The method of claim 8, further comprising dynamically executing the one or more functions for a user associated with a first user role based on the user profile.

10. The method of claim 7, wherein the context includes at least one of a time of day, a current weather, a time of year, and a day of the week.

11. A system for customizing a user profile for a vehicle, comprising:
a first module configured to, by a processor of a first device, customize a user profile defining vehicle access for one or more users of the vehicle;
a second module configured to, by a processor, provide an access key and the user profile through a first communication channel to a second device;
a third module, configured to, by a processor, provide the user profile through a second communication channel to the vehicle;
a fourth module configured to, by a processor, verify the user profile of the first communication channel with the user profile of the second communication channel, and in response to the verifying, store the access key in the vehicle.

12. The system of claim 11, wherein the first device is a user device of an owner of the vehicle, and wherein the second device is a user device of an other user of the vehicle.

13. The system of claim 11, wherein the first device is a fleet management server, and wherein the second device is a user device of a user of the vehicle.

14. The system of claim 11, wherein the first device is a user device of a user of the vehicle, and wherein the second device is a fleet management server.

15. The system of claim 11, wherein the first communication channel includes a uniform resource locator.

16. The system of claim 15, wherein the second communication channel includes a telematics system.

17. The system of claim 11, wherein the first module customizes the user profile by assigning one or more contexts to one or more functions of the vehicle.

18. The system of claim 17, wherein the first module customizes the user profile by assigning one or more functions to one or more user roles.

19. The system of claim 18, further comprising a fourth module that dynamically executes the one or more functions for a user associated with a first user role based on the user profile.

20. The system of claim 17, wherein the context includes at least one of a time of day, a current weather, a time of year, and a day of the week.
